(19) United States
(12) Patent Application Publication
(10) Pub. No.: US 2022/0319185 A1
(43) Pub. Date: Oct. 6, 2022

(54) METHOD FOR PREVENTING COLLISIONS IN BLIND AREA OF A VEHICLE, AND ELECTRONIC DEVICE USING THE SAME

(71) Applicant: Nanning FuLian FuGui Precision Industrial Co., Ltd., Nanning (CN)

(72) Inventor: XIANG-MIN ZHAO, Shenzhen (CN)

(21) Appl. No.: 17/566,223

(22) Filed: Dec. 30, 2021

(30) Foreign Application Priority Data
Mar. 31, 2021 (CN) 202110351901.5

(51) Int. Cl. G06V 20/58; H04W 4/40; G08G 1/16; G06V 40/10; B60T 7/22

(52) U.S. Cl. CPC G06V 20/58; H04W 4/40; G08G 1/167; G06V 40/103; B60T 7/22; B60T 2210/32; B60Q 9/008

(57) ABSTRACT

A method for preventing collisions with static or moving objects in the blind area of a vehicle being driven, applied in an electronic device, includes: obtaining images captured by camera installed on the driven vehicle by implementing a 5G communication method. The images are analyzed for the presence of obstacles. When the images show obstacles, recognizing contours of each obstacle and determining whether the contours of each obstacle is humanoid. When the contours of any obstacle have a human shape, analyzing an extent of the range of the blind area of the vehicle from the images and determining whether an obstacle is within the blind area range of the driven vehicle. If any obstacle is determined to be in the blind area, generating an alarm to the driver of the vehicle by implementing the 5G communication method to activate the alarm device.

### CROSS-REFERENCE TO RELATED APPLICATIONS

This application claims priority to Chinese Patent Application No. 202110351901.5 filed on Mar. 31, 2021, files in China National Intellectual Property Administration, the contents of which are incorporated by reference herein.

### FIELD

The subject matter herein generally relates to a field of road safety, and especially relates to a method for preventing collisions in blind area of a vehicle, and an electronic device.

### BACKGROUND

Being bigger and longer, large trucks have more blind areas than passenger vehicles, and a slight negligence of truck drivers can cause serious accidents. Usually, the blind area of the truck is in a range from an end of the trailer or cargo box to the cockpit at the other end, and about 1.5-2 meters away from the truck. The larger the container, the larger the blind area. The blind area is a potential hazard for both drivers and pedestrians on the road. Existing accident-avoidance method for the blind area of the truck includes providing a horn on the truck body to sound an alarm or display written warning in the blind area of the truck to warn pedestrians to be careful. A camera can also be installed on the body of the truck for the driver to view the blind area. However, the warnings may be ignored by pedestrians who are not paying attention. Furthermore, if the attention of the driver is directed to watching images of the blind area captured by the camera, the driver may not be focusing on the traffic on the road, and watching to the images will also increase the driver's fatigue. Therefore, an improved method for avoiding blind area accidents is desirable.

### BRIEF DESCRIPTION OF THE DRAWINGS

Implementations of the present disclosure will now be described, by way of embodiment, with reference to the attached figures.

FIG. 1 is a block diagram of one embodiment of a system for preventing collisions in blind area of a vehicle.

FIG. 2 is a flowchart of one embodiment of a method for preventing collisions in blind area of a vehicle.

FIG. 3 is a schematic diagram of one embodiment of an electronic device employing the method of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

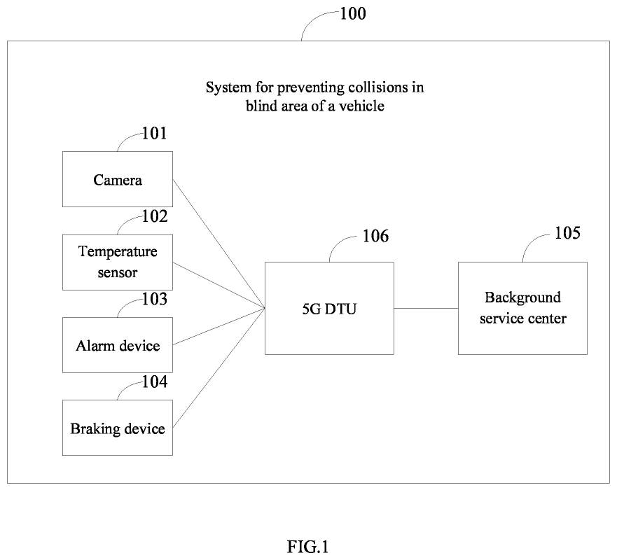

FIG. 1 illustrates a system 100 for preventing collisions in blind area of a vehicle. In one embodiment, the system 100 includes, but is not limited to, a camera 101, a temperature sensor 102, an alarm device 103, a braking device 104, a background service center 105, and a 5G data transfer unit (DTU) 106. In one embodiment, the camera 101, the temperature sensor 102, the alarm device 103, and the braking device 104 are connected to the 5G DTU 106 by an RS232 or an RS484 interface. The 5G DTU 106 is connected to the background service center 105 by implementing the 5G communication method. In one embodiment, the 5G DTU 106 is communicatively connected to the background service center 105 by a 5G base station.

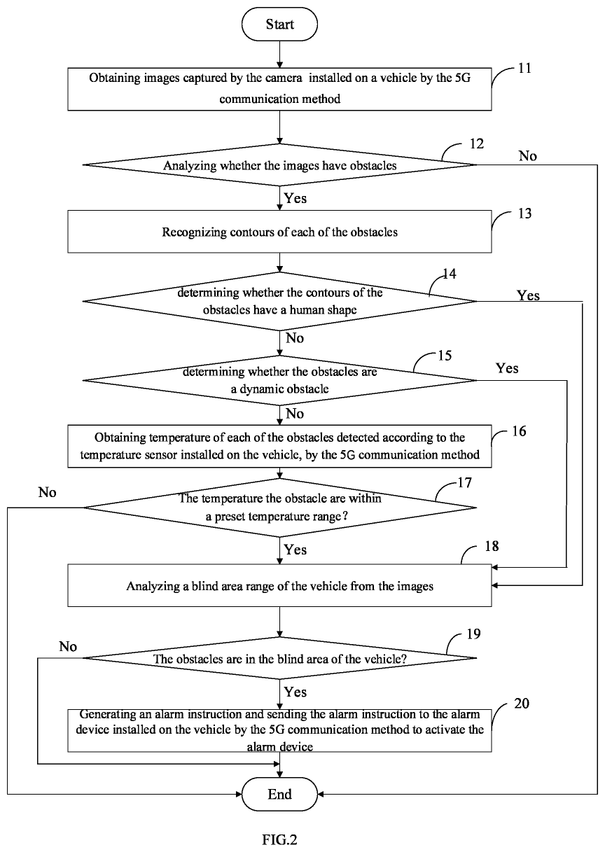

FIG. 2 illustrates the method for preventing collisions in blind area of a vehicle. The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 11.

At block 11, obtaining images captured by the camera 101 installed on a vehicle by implementing the 5G communication method.

In one embodiment, the camera 101 captures images within blind area of the vehicle and transmits the captured images to the background service center 105 by the 5G DTU 106. In one embodiment, the camera 101 is connected to the 5G DTU 106 by the RS232 or RS484 interface. The 5G DTU 106 is connected to the background service center 105 by implementing the 5G communication method. For example, the 5G DTU 106 is connected to the background service center 105 by the 5G base station. The camera 101 transmits the captured images to the 5G DTU 106 by the RS232 or RS484 interface, and the 5G DTU 106 transmits the image to the background service center 105 by the 5G base station. In one embodiment, the background service center 105 can be a single server, a server cluster, or a cloud server.

In one embodiment, the number of cameras 101 installed on the vehicle is more than one. The cameras 101 are installed on the vehicle and can capture images of the blind area of the vehicle. In one embodiment, the number of cameras 101 is five. One camera 101 is installed at the rear of the vehicle, two cameras 101 are installed on both sides of a cargo box of the vehicle and adjacent to a cockpit of the vehicle, and the other two cameras 101 are installed on each side of the cockpit of the vehicle.

At block 12, analyzing whether the images have obstacles.

When the images have obstacles, block 13 is executed, otherwise, when no obstacles are shown, the flow of the method ends.

In one embodiment, after acquiring the images, the background service center 105 analyzes whether obstacles are shown in the images. In one embodiment, the background service center 105 analyzes the images for obstacles based on a deep learning model. For example, the background service center 105 analyzes whether the images have images by a classification model. In one embodiment, the possible obstacles include, but are not limited to, a static object with a volume greater than a preset volume, and a moving object (dynamic obstacle) of any size.

At block 13, recognizing contours of each of the obstacles.

In one embodiment, the background service center 105 recognizes the contours of each of the obstacles by a visual recognition algorithm.

At block 14, determining whether the contours of each of the obstacles have a human shape. When such contours have the human shape, block 18 is executed. Otherwise, when the contours are not humanoid, block 15 is executed.

At block 15, determining whether each of the obstacles is a dynamic obstacle.

When any of the obstacle is a dynamic obstacle, block 18 is executed, otherwise, when all of the obstacles are static and unmoving (such as a static obstacle), block 16 is executed.

In one embodiment, determining whether each of the obstacles is a dynamic obstacle includes: detecting moving speed of each of the obstacles relative to the vehicle; determining whether the moving speed of each of the obstacles is within a preset speed range. If an obstacle has moving speed within the preset speed range, it is determined to be the dynamic obstacle. It should be noted that setting the preset speed range in relation to dynamic obstacles must take account of the moving speed of the vehicle.

At block 16, obtaining temperature of each of the obstacles detected according to the temperature sensor 102 installed on the vehicle, by implementing the 5G communication method.

In one embodiment, the temperature sensor 102 senses the temperature of each of the obstacles and transmits the temperature of each of the obstacles to the background service center 105 by the 5G DTU 106. In one embodiment, the temperature sensor 102 is connected to the 5G DTU 106 by the RS232 or RS484 interface, and the 5G DTU 106 is connected to the background service center 105 by the 5G base station. In one embodiment, the temperature sensor 102 transmits the temperature of each of the obstacles to the 5G DTU 106 by the RS232 or RS484 interface, and the 5G DTU 106 transmits the temperature of each obstacle to the background service center 105 by the 5G base station.

At block 17, determining whether the temperature of each of the obstacle is within a preset temperature range.

When the temperature of any of the obstacles is within the preset temperature range, block 18 is executed. Otherwise, if no obstacle has a temperature within the preset temperature range, the flow of the method ends.

At block 18, analyzing a blind area range of the vehicle from the images.

In one embodiment, analyzing the blind area range of the vehicle from the images includes: setting a preset range area within the images as the blind area range of the vehicle; determining the preset range area from the images, and taking the preset range area as the blind area range of the vehicle.

At block 19, determining whether each of the obstacles is in the blind area of the vehicle.

When there are obstacles is in the blind area of the vehicle, block 20 is executed. Otherwise, if there are no obstacles in the blind area of the vehicle, the flow of the method flow ends.

At block 20, generating an alarm instruction and sending the alarm instruction to the alarm device 103 installed on the vehicle by implementing the 5G communication method, to activate the alarm device 103.

In one embodiment, the method further includes: when any obstacle is in the blind area of the vehicle, generating a vehicle braking instruction, and sending the instruction to brake the vehicle to the braking device 104 installed on the vehicle, by implementing the 5G communication method to activate the braking device 104.

In one embodiment, the background service center 105 obtains the images captured by the camera 101 arranged on the vehicle by implementing the 5G communication method, analyzes the obstacles to obtain the blind area range from the images, and sends an alarm instruction to the alarm device 103 by implementing the 5G communication method. When it is determined that an obstacle is within the blind area range of the vehicle, the above process avoids a collision between the vehicle and the obstacle in the blind area, improving road safety in respect of the vehicle blind area.

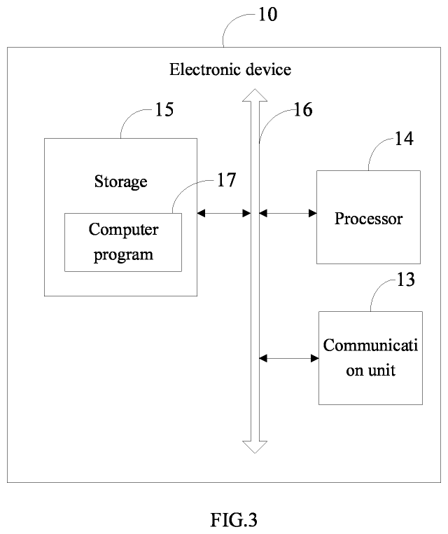

FIG. 3 illustrates the electronic device 10. The electronic device 10 includes a communication unit 13, a processor 14, a storage 15, and a computer program 17. The communication unit 13, the processor 14, and the storage 15 may be connected by one or more communication buses 16. In one embodiment, the communication unit 13 is a 5G communication module. The storage 15 is used to store one or more computer programs 17. One or more computer programs 17 are configured to be executed by the processor 14. The one or more computer programs 17 include a plurality of instructions. When the plurality of instructions are executed by the processor 14, the method is executed on the electronic device 10 to achieve collision-prevention in vehicle blind area. In one embodiment, the electronic device 10 can be a device installed on the vehicle or the vehicle itself. In one embodiment, the electronic device 10 includes a background service center 105 or a server.

In one embodiment, the present application also provides a computer storage medium in which computer instructions are stored. When the computer instructions are executed on the electronic device 10, the electronic device 10 is caused to execute the above steps of the method in the above embodiment.

In one embodiment, the present application also provides a computer program product. When the computer program product is executed on the computer, the computer is caused to perform the above steps of the method.

In one embodiment, the present application also provides a device, which can be a chip, component, or module, and the device can include a connected processor and a storage. The storage is used to store computer execution instructions. When the device is running, the processor can execute the computer execution instructions stored in the storage to enable the method in the above embodiments.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A method of preventing collisions in blind area of a vehicle, comprising:
obtaining images captured by a camera on a vehicle;
analyzing whether the images comprises images of obstacles;
recognizing contours of each of the obstacles when the images contain images of obstacles;
determining whether the contours of each of the obstacles contain a human shape;
analyzing a blind area range of the vehicle from the images when the contours of any of the obstacles contain the human shape;
determining whether each of the obstacles is in the blind area of the vehicle;
generating an alarm instruction and sending the alarm instruction to an alarm device on the vehicle when any of the obstacles is in the blind area of the vehicle.

2. The method as recited in claim 1, wherein obtaining the images captured by the camera on the vehicle comprising:
transmitting, by the camera, the images to a 5G data transfer unit (DTU) by a RS232 or a RS484 interface; and
transmitting the images to a background service center by the 5G DTU.

3. The method as recited in claim 1, wherein analyzing whether the images comprise images of obstacles comprising:
analyzing the images based on a deep learning model.

4. The method as recited in claim 1, further comprise:
determining whether each of the obstacles is dynamic when the contours of all of the obstacles do not contain the human shape;
analyzing the blind area range of the vehicle from the images when any of the obstacle is dynamic; and
generating the alarm instruction and sending the alarm instruction to the alarm device when any of the obstacles is in the blind area of the vehicle.

5. The method as recited in claim 4, wherein determining whether each of the obstacles is dynamic comprises:
detecting a moving speed of each of the obstacles relative to the vehicle;
determining whether the moving speed of each of the obstacles is within a preset speed range; and
determining an obstacle whose moving speed is within the preset speed range to be dynamic.

6. The method as recited in claim 4, further comprises:
obtaining a temperature of each of the obstacles according to a temperature sensor on the vehicle when all of the obstacles are not dynamic;
determining whether the temperature of each of the obstacle is within a preset temperature range;
analyzing the blind area range of the vehicle from the images when the temperature of any of the obstacles is within the preset temperature range, and generating the alarm instruction and sending the alarm instruction to the alarm device when any of the detected obstacles is in the blind area of the vehicle.

7. The method as recited in claim 1, wherein analyzing a blind area range of the vehicle from the images comprises:
setting a preset range area in the images as the blind area range of the vehicle; and
determining the preset range area from the images, and taking the preset range area as the blind area range of the vehicle.

8. The method as recited in claim 1 further comprises:
generating a vehicle braking instruction when any of the obstacles is in the blind area of the vehicle; and
sending the vehicle braking instruction to a braking device on the vehicle to make the braking device brake the vehicle.

9. An electronic device comprising:
a processor; and
a non-transitory storage medium coupled to the processor and configured to store a plurality of instructions, which cause the processor to:
obtain images captured by camera on a vehicle;
analyze whether the images comprises images of obstacles;
recognize contours of each of the obstacles when the images contain images of obstacles;
determine whether the contours of each of the obstacles contain a human shape;
analyze a blind area range of the vehicle from the images when the contours of any of the obstacles contain the human shape;
determine whether each of the obstacles is in the blind area of the vehicle;
generate an alarm instruction and send the alarm instruction to an alarm device on the vehicle when any of the obstacles is in the blind area of the vehicle.

10. The electronic device as recited in claim 9, wherein the plurality of instructions are further configured to cause the processor to:
analyze the images based on a deep learning model.

11. The electronic device as recited in claim 9, wherein the plurality of instructions are further configured to cause the processor to:
determine whether each of the obstacles is a dynamic obstacle when the contours of all of the obstacles do not contain the human shape;
analyze the blind area range of the vehicle from the images when any of the obstacle is dynamic; and
generate the alarm instruction and send the alarm instruction to the alarm device when any of the obstacles is in the blind area of the vehicle.

12. The electronic device as recited in claim 11, wherein the plurality of instructions are further configured to cause the processor to:
detect a moving speed of each of the obstacles relative to the vehicle;
determine whether the moving speed of each of the obstacles is within a preset speed range; and
determine an obstacle whose moving speed is within the preset speed range to be dynamic.

13. The electronic device as recited in claim 11, wherein the plurality of instructions are further configured to cause the processor to:
obtain a temperature of each of the obstacles according to a temperature sensor on the vehicle when all of the obstacles are not dynamic;
determine whether the temperature of each of the obstacle is within a preset temperature range;
analyze the blind area range of the vehicle from the images when the temperature of any of the obstacles is within the preset temperature range, and, generate the alarm instruction and send the alarm instruction to the alarm device when any of the obstacles is in the blind area of the vehicle.

14. The electronic device as recited in claim 9, wherein the plurality of instructions are further configured to cause the processor to:
set a preset range area in the images as the blind area range of the vehicle; and
determine the preset range area from the images, and take the preset range area as the blind area range of the vehicle.

15. The electronic device as recited in claim 9, wherein the plurality of instructions are further configured to cause the processor to:
generate a vehicle braking instruction when any of the obstacles is in the blind area of the vehicle; and
send the vehicle braking instruction to a braking device on the vehicle to make the braking device brake the vehicle.

16. A non-transitory storage medium having stored thereon instructions that, when executed by at least one processor of an electronic device, causes the least one processor to execute instructions of a method for preventing collisions in blind area of a vehicle, the method comprising:
obtaining images captured by camera on a vehicle;
analyzing whether the images comprises images of obstacles;
recognizing contours of each of the obstacles when the images contain images of obstacles;
determining whether the contours of each of the obstacles contain a human shape;
analyzing a blind area range of the vehicle from the images when the contours of any of the obstacles contain the human shape; and
determining whether each of the obstacles is in the blind area of the vehicle, wherein
generating an alarm instruction and sending the alarm instruction to an alarm device on the vehicle when any of the obstacles is in the blind area of the vehicle.

17. The non-transitory storage medium as recited in claim 16, wherein the method for preventing the collisions in blind area of the vehicle comprising:
determining whether each of the obstacles is dynamic when the contours of all of the obstacles do not have the human shape;
analyzing the blind area range of the vehicle from the images when any of the obstacle is dynamic; and
generating the alarm instruction and sending the alarm instruction to the alarm device when any of the obstacles is in the blind area of the vehicle.

18. The non-transitory storage medium as recited in claim 17, wherein the method for preventing the collisions in blind area of the vehicle comprising:
detecting a moving speed of each of the obstacles relative to the vehicle;
determining whether the moving speed of each of the obstacles is within a preset speed range; and
determining an obstacle whose moving speed is within the preset speed range to be dynamic.

19. The non-transitory storage medium as recited in claim 17, wherein the method for preventing the collisions in blind area of the vehicle comprising:
obtaining a temperature of each of the obstacles according to a temperature sensor on the vehicle when all of the obstacles are not dynamic;
determining whether the temperature of each of the obstacle is within a preset temperature range;
analyzing the blind area range of the vehicle from the images when the temperature of any of the obstacles is within the preset temperature range, and generating the alarm instruction and sending the alarm instruction to the alarm device when any of the obstacles is in the blind area of the vehicle.

20. The non-transitory storage medium as recited in claim 16, wherein the method for preventing the collisions in blind area of the vehicle comprising:
setting a preset range area in the images as the blind area range of the vehicle; and
determining the preset range area from the images, and taking the preset range area as the blind area range of the vehicle.
